(19) United States
(12) Patent Application Publication
(10) Pub. No.: US 2010/0105394 A1
(43) Pub. Date: Apr. 29, 2010

(54) METHODS AND SYSTEMS FOR SELECTIVE DATA COMMUNICATIONS FOR MULTI-MODE DEVICES

(75) Inventors: Steven D. Cheng, San Diego, CA (US); Tom Chin, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/260,341

(22) Filed: Oct. 29, 2008

(51) Int. Cl. H04W 36/14

(52) U.S. Cl. 455/440

(57) ABSTRACT

A method and apparatus for selectively utilizing short-range radio access technologies (RATs) when available to connect a multi-mode wireless device to a network are provided.

### TECHNICAL FIELD

Certain embodiments of the present disclosure generally relate to wireless communication and, more particularly, to a wireless device capable of communicating with multiple radio access technologies (RATs).

### SUMMARY OF THE DISCLOSURE

Certain embodiments provide a method of providing a multi-mode mobile station access to a network. The method generally includes determining a location of the mobile station while the mobile station is connected to the network via a long-range radio access technology (RAT) base station, identifying, based at least in part on the location, a short-range RAT access point available to connect the mobile station to the network, and directing the mobile station to switch to a connection to the network via the short-range RAT access point.

Certain embodiments provide a method of accessing a network by a multi-mode mobile station. The method generally includes providing a location of the mobile station via a long-range radio access technology (RAT) base station, receiving direction to switch to a connection to the network via a short-range RAT access point, and establishing a connection with the short-range RAT access point.

Certain embodiments provide an apparatus for providing a multi-mode mobile station access to a network. The apparatus generally includes logic for determining a location of the mobile station while the mobile station is connected to the network via a long-range radio access technology (RAT) base station, logic for identifying, based at least in part on the location, a short-range RAT access point available to connect the mobile station to the network, and logic for directing the mobile station to switch to a connection to the network via the short-range RAT access point.

Certain embodiments provide an apparatus for providing a multi-mode mobile station access to a network. The apparatus generally includes logic for providing a location of the mobile station via a long-range radio access technology (RAT) base station, logic for receiving direction to switch to a connection to the network via a short-range RAT access point, and logic for establishing a connection with the short-range RAT access point.

Certain embodiments provide an apparatus for providing a multi-mode mobile station access to a network. The apparatus generally includes means for determining a location of the mobile station while the mobile station is connected to the network via a long-range radio access technology (RAT) base station, means for identifying, based at least in part on the location, a short-range RAT access point available to connect the mobile station to the network, and means for directing the mobile station to switch to a connection to the network via the short-range RAT access point.

Certain embodiments provide an apparatus for providing a multi-mode mobile station access to a network. The apparatus generally includes means for providing a location of the mobile station via a long-range radio access technology (RAT) base station, means for receiving direction to switch to a connection to the network via a short-range RAT access point, and means for establishing a connection with the short-range RAT access point.

Certain embodiments provide a computer-program product for providing a multi-mode mobile station access to a network, comprising a computer readable medium having instructions stored thereon, the instructions being executable by one or more processors. The instructions generally include instructions for determining a location of the mobile station while the mobile station is connected to the network via a long-range radio access technology (RAT) base station, instructions for identifying, based at least in part on the location, a short-range RAT access point available to connect the mobile station to the network, and instructions for directing the mobile station to switch to a connection to the network via the short-range RAT access point.

Certain embodiments provide a computer-program product for providing a multi-mode mobile station access to a network, comprising a computer readable medium having instructions stored thereon, the instructions being executable by one or more processors. The instructions generally include instructions for providing a location of the mobile station via a long-range radio access technology (RAT) base station, instructions for receiving direction to switch to a connection to the network via a short-range RAT access point, and instructions for establishing a connection with the short-range RAT access point.

In certain embodiments, as described within this disclosure, a short-range RAT access point can include an access point that communicates in accordance with at least one of the IEEE 802.11 family of standards.

In certain embodiments, as described within this disclosure, a long-range RAT base station can include a base station that communicates in accordance with at least one of the IEEE 802.16 family of standards.

In certain embodiments, as described within this disclosure, a long-range RAT base station can include a base station that communicates via time division multiple access (TDMA).

In certain embodiments, as described within this disclosure, a long-range RAT base station can include a base station that communicates via code division multiple access (CDMA).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system in accordance with certain embodiments of the present disclosure.

FIG. 4 illustrates an example multi-mode mobile station, in accordance with certain embodiments of the present disclosure.

FIGS. 5A and 5B illustrate an example multi-RAT wireless network with evenly and unevenly distributed MSs, respectively, in accordance with certain embodiments of the present disclosure.

FIG. 6 illustrates example operations for communicating with a multi-mode MS, in accordance with certain embodiments of the present disclosure.

FIG. 7 illustrates example operations for communicating with a multi-mode MS, in accordance with certain embodiments of the present disclosure.

FIG. 7A illustrates example components capable of performing the operations shown in FIG. 7.

FIG. 8 illustrates an example multi-RAT wireless network with traffic distributed between long-range and short-range RATs, in accordance with certain embodiments of the present disclosure.

### DETAILED DESCRIPTION

Wireless communication systems typically utilize a network of base stations to communicate with wireless devices (i.e., mobile stations) registered for services in the systems. Each base station (BS) emits and receives radio frequency (RF) signals that convey data to and from the mobile stations (MS). The BSs are typically connected by a backbone of wired connection to a provider network.

In such systems, the air resources used are typically considered much more expensive than the wireline communication. Further, it is typically much more expensive to expand the wireless network rather than it is to expand the wireline network. Part of the expense is due to the difficulty in balancing the load between base stations due to an inability to accurately predict a peak rate of the mobile users in a certain network. A peak rate is difficult to predict because the mobile users can freely move from one place to another.

As a result, a network may experience congestion when the number of the mobile users in a local mobile network grows such that the bandwidth demand is beyond what the network can handle.

By selectively utilizing short-range radio access technologies (RATs) when available to connect a multi-mode mobile device to a network, embodiments of the present disclosure may help ease traffic congestion of long-range RATs, effectively increasing available bandwidth.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One specific example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

IEEE 802.16x is an emerging standard organization to define an air interface for fixed and mobile broadband wireless access (BWA) systems. Those standards define at least four different physical layers (PHYs) and one media access control (MAC) layer. The OFDM and OFDMA physical layer of the four physical layers are the most popular in the fixed and mobile BWA areas respectively.

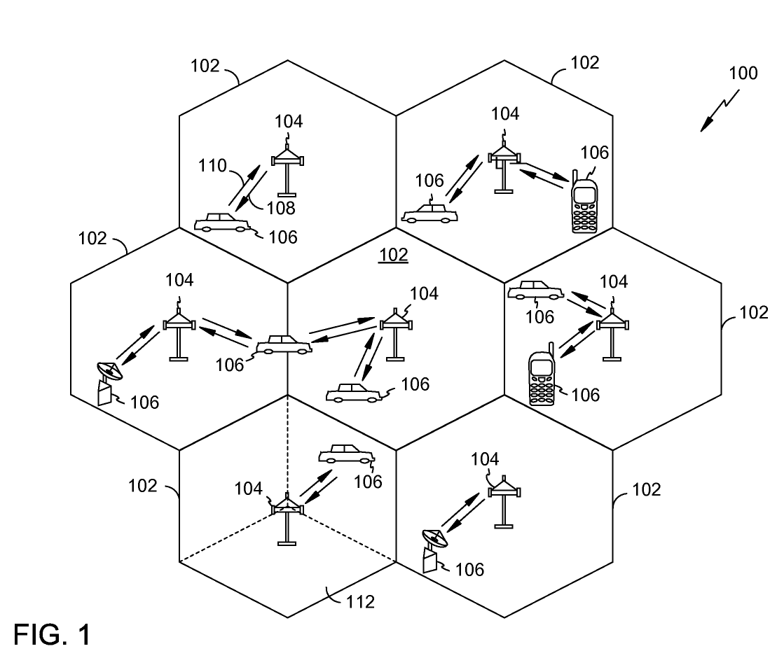

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the wireless communication system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

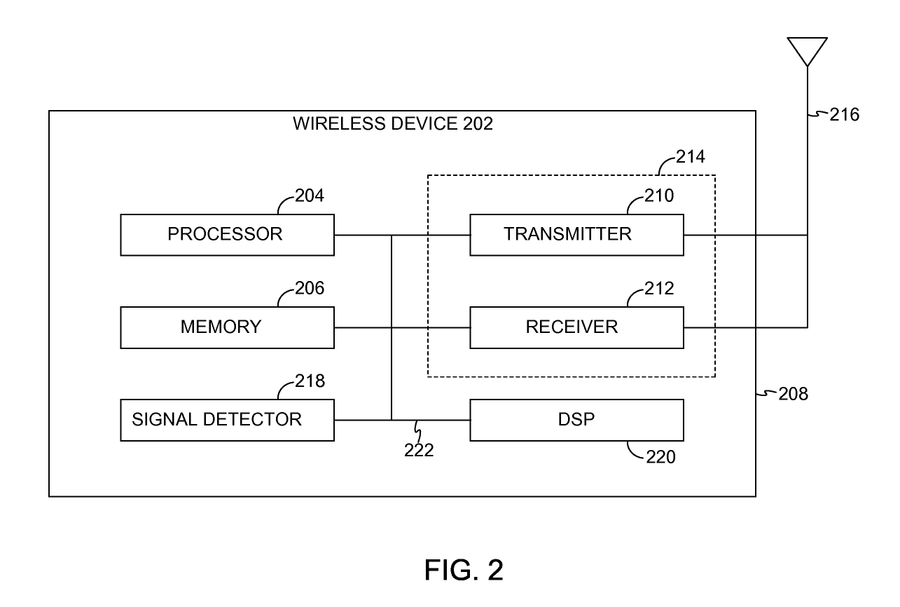

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per pseudonoise (PN) chips, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

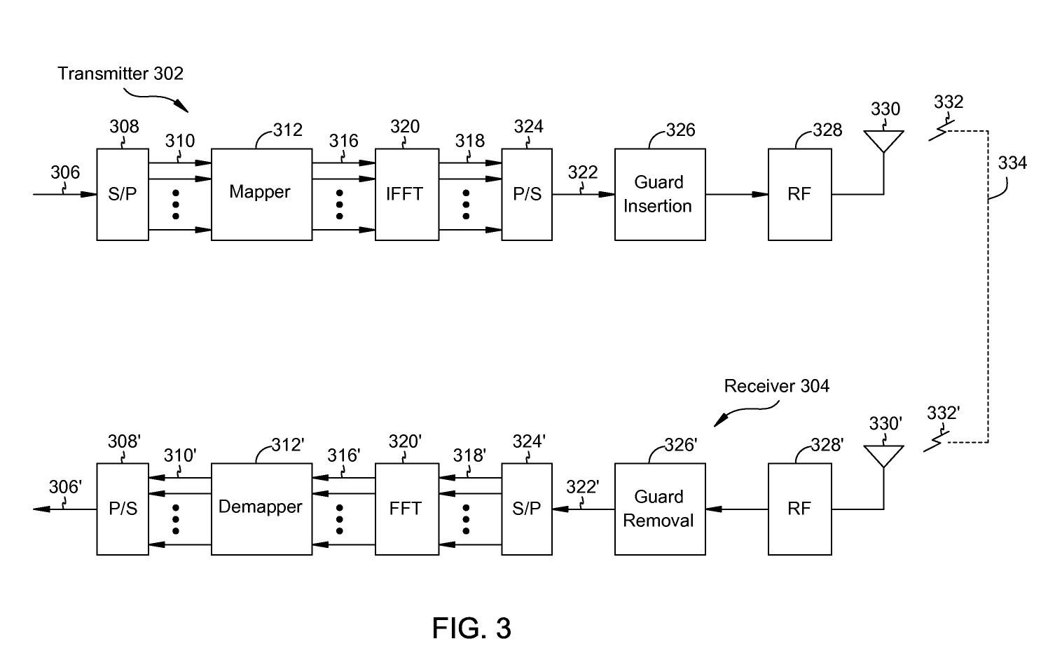

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found on a in a baseband processor 340′.

Exemplary Selective Data Communication Techniques for Multi-Mode Devices that Support Long and Short Range RATs

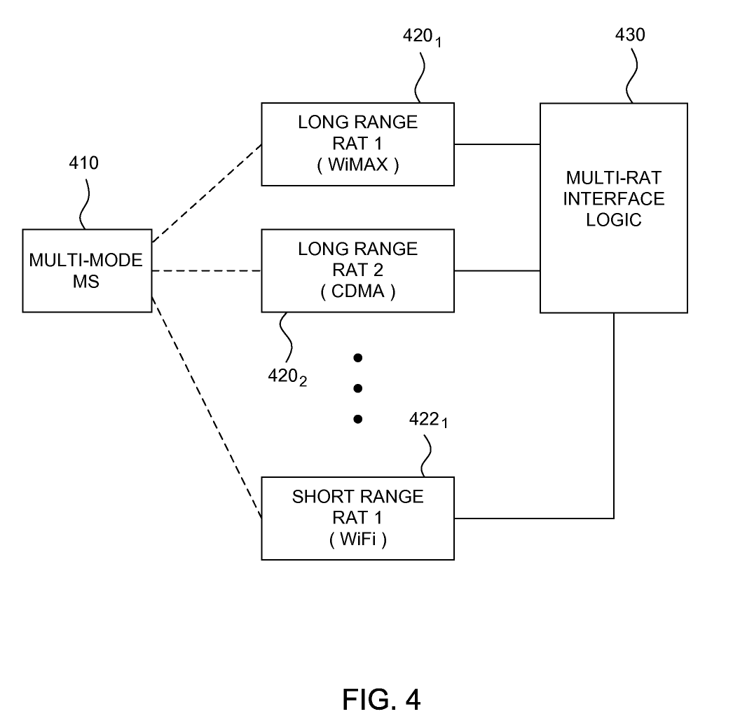

In order to expand the services available to subscribers, some MSs support communications with multiple radio access technologies (RATs). For example, as illustrated in FIG. 4, a multi-mode MS 410 may support WiMAX for broadband data services and code division multiple access (CDMA) for voice services. Illustratively, WiMAX is shown as a first long-range RAT 4201, while CDMA is shown as a second long-range RAT 4202. In addition to supporting one or more long-range RATs, the multi-mode MS 410 may support one or more short-range RATs, such as Bluetooth, wireless local area network (WLAN) or Wi-Fi (shown as short-range RAT 4221).

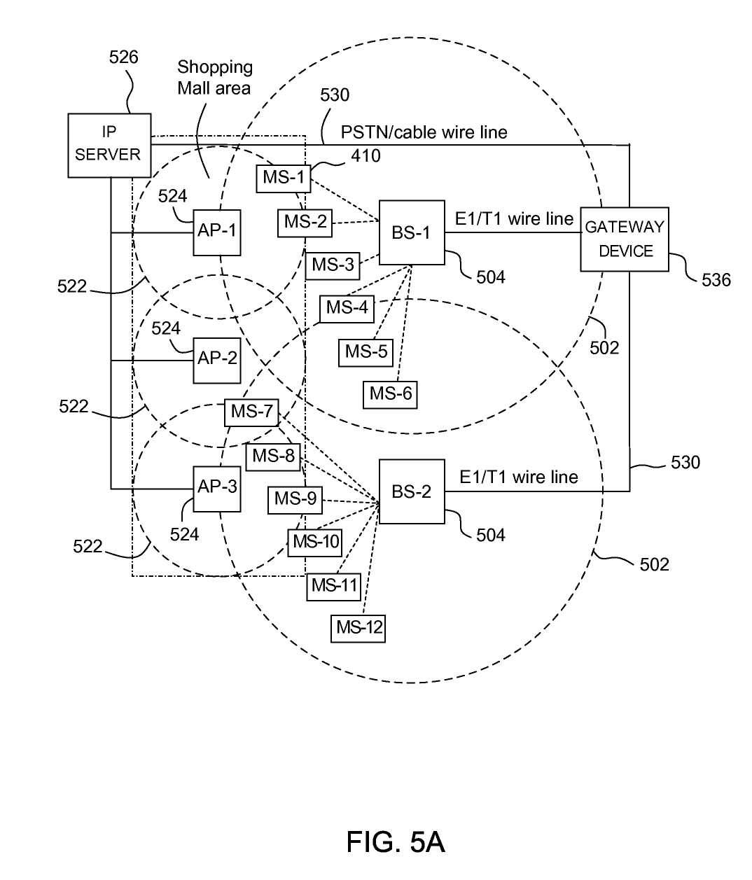

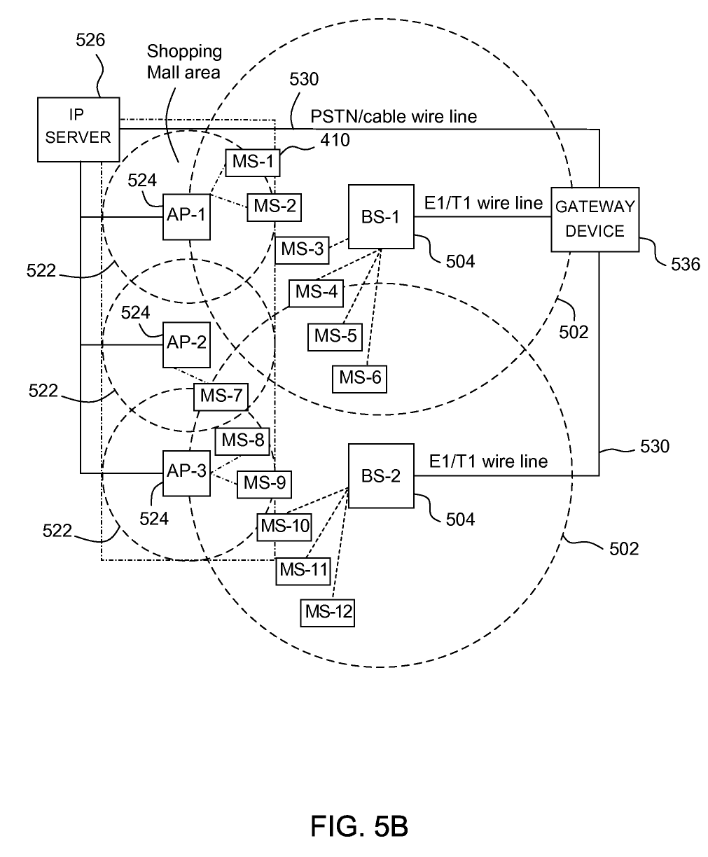

In certain applications, multi-RAT interface logic 430 may be used to exchange information between both long-range and short-range RATs. This may enable a network provider to control how (through which RAT) an end user of the multi-mode MS 410 actually connects to the network. The multi-RAT interface logic 430 may, for example, communicate with various short range RAT components, such as an IP server 526 (shown in FIG. 5), and long-range RAT components, such as a gateway device 536 (also shown in FIG. 5).

For example, a network provider may be able to direct the multi-mode MS to connect to the network via short-range RAT, when available. This capability may allow a network provider to route traffic in a manner that eases congestion of particular air resources. In effect, the network provider may use short-range RATs to distribute some air traffic (of a long-range RAT) into a wireline network (e.g., PSTN) or to distribute some air traffic from a congested wireless network to a less congested wireless network. The traffic may be re-routed from the short-range RAT when conditions mandate, such as when a mobile user increases speed to a certain level not suitable for a short-range RAT.

Further, since long-range RATs are typically designed to provide service over several kilometers, the power consumption of transmissions from a multi-mode MS when using a long-range RAT is non-trivial. In contrast, short-range RATs (e.g., Wi-Fi) are designed to provide service over several hundred meters. Accordingly, utilizing a short-range RAT when available may result in less power consumption by the multi-mode MS 410 and, consequently, longer battery life.

FIG. 5A illustrates an example network, with access to a network in different regions, inside and outside a shopping mall, provided by overlapping coverage areas 502 and 522 of long-range RAT BSs 504 and short-range RAT APs 524, respectively. While the terms base station (BS) and access point (AP) may be used interchangeably and generally refer to devices or nodes that allow a mobile station (MS) or access terminal (AT) to access a network, the term base station will generally be used in the following disclosure when referring to long rang RATs, while the term access point will be used when referring to short range RATs.

In the illustrated example, the network may provide access to a plurality of MSs through a first long-range RAT BS 1 504 (e.g., a WiMAX or CDMA BS or GSM using TDMA), a second long-range RAT BS 2 504, as well as several short-range RAT BSs 1-3 524 (e.g., a WLAN or Wi-Fi BSs), for example, that provide access to the network within the shopping mall. Each BS is connected to the network through wirelines 530 (e.g., E1 lines, T1 lines, PSTN lines, and cable lines).

The base stations are typically arranged according to network planning that assumes a well-distributed distribution of MSs. In this example, MS-1, MS-2, MS-4, MS-5, and MS-6 are in coverage area of long-range RAT BS-1 and, thus, may connect to the network via long-range RAT BS 1. Meanwhile, MS-7, MS-8, MS-9, MS-10, MS-11, and MS-12, are in coverage area of long-range RAT BS-2 and, thus may, may connect to the network via long-range RAT BS 2.

Unfortunately, as the number of mobile users increases, the network may experience congestion as the aggregate bandwidth demand of the users in a particular coverage area exceeds the bandwidth the corresponding BS can handle. However, embodiments of the present disclosure may allow some traffic for MSs that are in an overlapping coverage area to be re-routed, away from long-range RATs to short-range RATs, when possible, to help ease traffic congestion of air resources.

For example, because mobile stations MS-1 and MS-2 are in an area of overlapping coverage by short-range RAT BS-1 and long-range RAT BS-1, MS-1 and MS-2 may be directed to connect to the network via short-range RAT BS-1, as shown in FIG. 5B. Similarly, because mobile station MS-7 is in an area of overlapping coverage by short-range RAT BS-2 and long-range RAT BS-2, MS-7 may be directed to connect to the network via short-range RAT BS-2, while mobile stations MS-8 and MS-9 (in an area of overlapping coverage by short-range RAT BS3 and long-range RAT BS-2) may be directed to connect to the network via short-range RAT BS-3.

Thus, in this example, traffic flows from five of twelve MSs are re-distributed from the air interface of the long-range RAT BSs to the network connection through wireline 530 of the short-range RAT through IP Server 526. As a result, the long-range RAT BSs may experience a reduction in network congestion. As will be described in greater detail below, traffic may be routed back to the long-range RAT BSs under certain conditions, for example, if a mobile user increases their speed to an amount that makes maintaining a connection via the short-range RAT unpractical.

By making this traffic routing transparent to mobile users, a network provider may virtually expand network capacity without further investment and may accommodate more mobile users in the same network at the same time. As will be discussed in detail below, a mobile station may only need to provide a location update, while the operations to detect a speed of the MS and control the switching between short and long-range RATs may be performed on the network side.

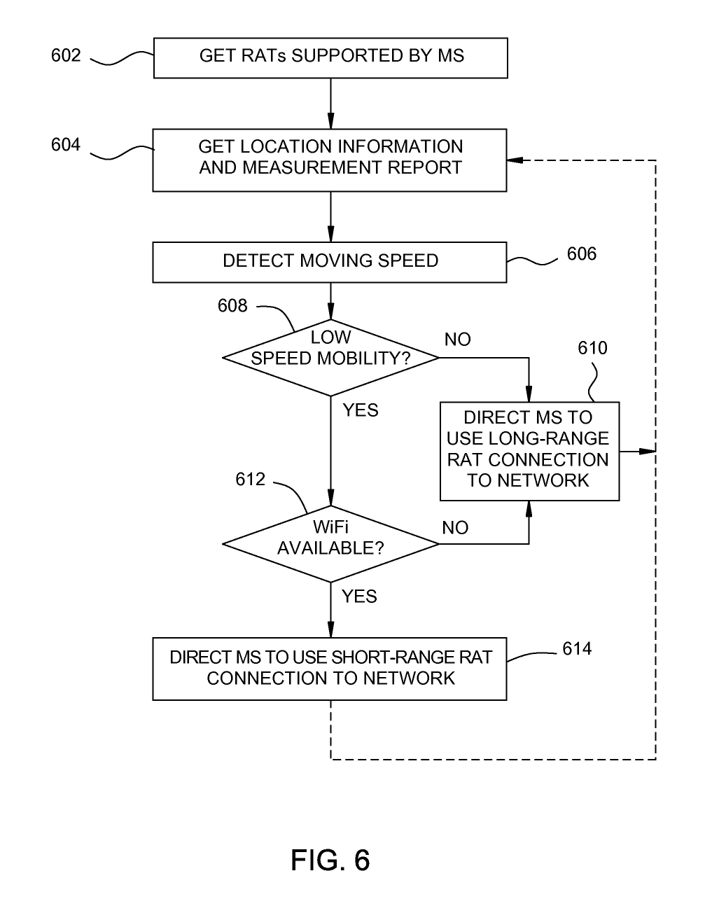

FIG. 6 illustrates example operations that may be performed to route traffic, in accordance with certain embodiments of the present disclosure. The operations may be performed, for example, by base stations or by multi-RAT interface logic 140 shown in FIG. 4 in communication with components of different short and long-range RATs, such as IP server 526 and/or gateway device 536, in order to direct a MS to establish connections to the network accordingly.

The operations begin, at 602, by receiving a list of RATs supported by an MS. For example, a multi-mode MS may send a list of all RATs supported when registering with a long-range RAT base station.

At 604, location information and a measurement report is obtained. For example, the location information may be provided by the MS (e.g., as global positioning system-GPS coordinates) or may be determined based on some other information, such as which base stations (BSs) or access points (APs) the MS is communicating with.

At 606, the moving speed of the MS may be detected. The moving speed may be detected, for example, based on a distance determined by the location updates and a time between location updates. The moving speed and/or location(s) of the MS may be used to determine, at 608, if the MS is in a low speed mobility mode (e.g., considered suitable for connection via short-range RAT) or a high speed mobility mode (e.g., considered less suitable for connection via short-range RAT).

For example, the moving speed may be compared against a threshold to determine if the MS is in a high or low speed mobility mode. For example, an MS may be considered in a high speed mobility mode if the detected moving speed is greater than a threshold speed at which communication with a short-range RAT is considered difficult. In addition, or as an alternative, the proximity to a short-range RAT boundary may also be considered. For example, even if an MS is not moving that fast, if it is close to a boundary and appears to be moving out of the coverage area of a short-range RAT, it may be considered to be in a high speed mobility mode.

If a device is considered to be in a high speed mobility mode, as determined at 608, the MS may be directed to use a long-range RAT to connect to the network, at 610. If the device is considered to be in a low speed mobility mode, a determination may be made, at 612, as to the availability of a short-range RAT (such as Wi-Fi) to access the network. A short-range RAT connection may be considered available, for example, if there is a nearby access point (e.g., determined based on location) that has sufficient signal strength (e.g., determined based on the measurement report). If a short-range RAT is available, the MS may be directed to use the short-range RAT to connect to the network, at 614.

To identify a nearby short-range RAT base station (access point) the MS can connect through in low speed mobility mode, network operators may utilize access point information identifying locations of access points (e.g., such as Wi-Fi or WLAN access points) for the short-range RATs supported by the MS. Such information may be maintained, for example, in a database by a network provider and updated periodically, to add entries for new access points, remove entries for access points no longer available, or modify existing entries for access points. Using this information, when the location information is obtained, the nearby access point for all the wireless RATs may be derived. If there are multiple access points nearby a given MS location, other factors may be considered to select an access point to direct the MS to, such as signal strength (indicated in the measurement report obtained at 604).

In order to provide a seamless switch from a long-range RAT to a short-range RAT, once a short-range RAT access point is identified, the network may direct the MS to connect to the network via a network server (such as IP server 526) connected to the network with the wireline 530 concurrently with a current active long-range RAT connection during the handover process. Once both connections are established successfully, the network can direct the mobile device to do the handover from the long-range wireless protocols to the short-range wireless protocol and the whole handover process is transparent to the mobile users.

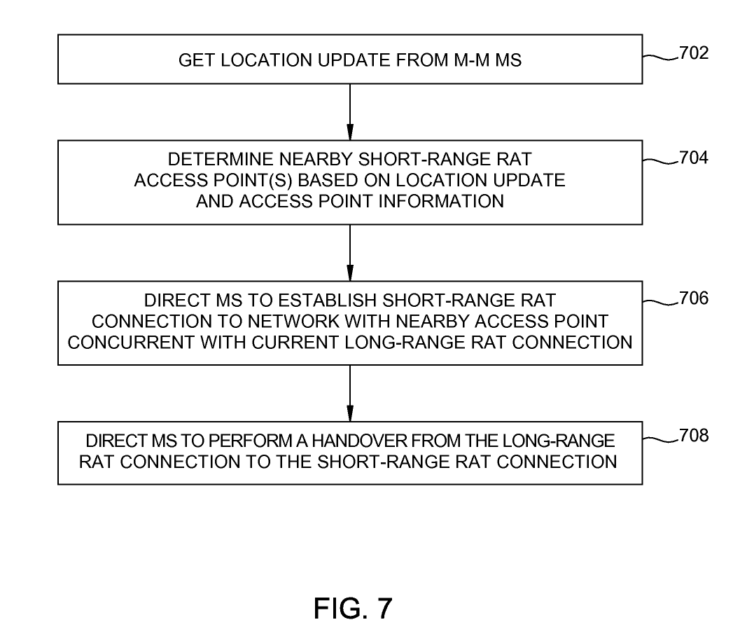

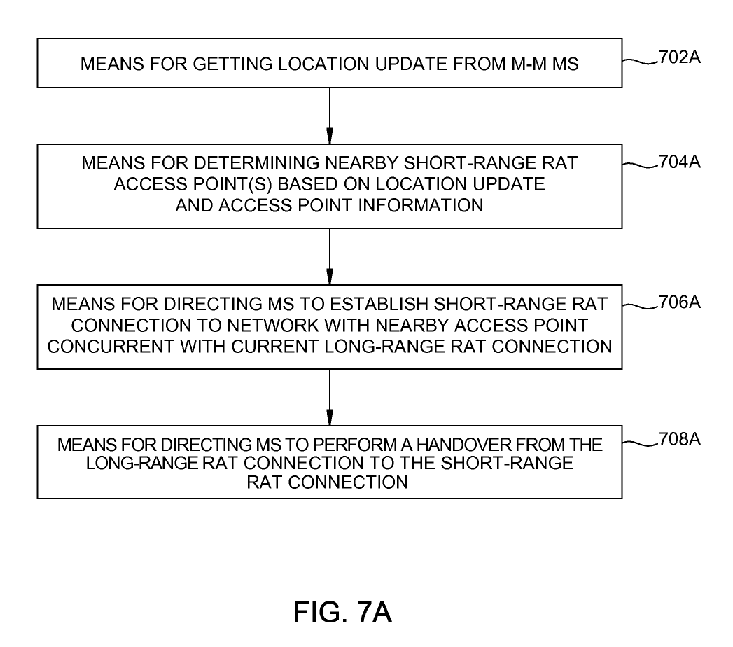

FIG. 7 illustrates operations for handing over from a long-range RAT to a short-range RAT. The operations begin, at 702, by obtaining a location update. At 704, one or more nearby access point(s) are determined based on the location update and access point information. At 706, the MS may be directed to establish a connection to the network via the nearby access point concurrent with a current long-range RAT connection. At 708, the MS may be directed to perform a handover from the long-range RAT connection to the short-range RAT connection.

By performing the operations in this manner, an MS may be directed to perform a handover only after establishing the connection via the nearby access point, which may reduce the possibility of an interruption in service to the end user if there is a problem establishing the short-range RAT connection. If there is a problem establishing the short-range RAT connection, the MS may simply continue to use the long-range RAT connection. While there will be no reduction in traffic from the long-range RAT in this case, at least the end user may not suffer any noticeable interruption in service.

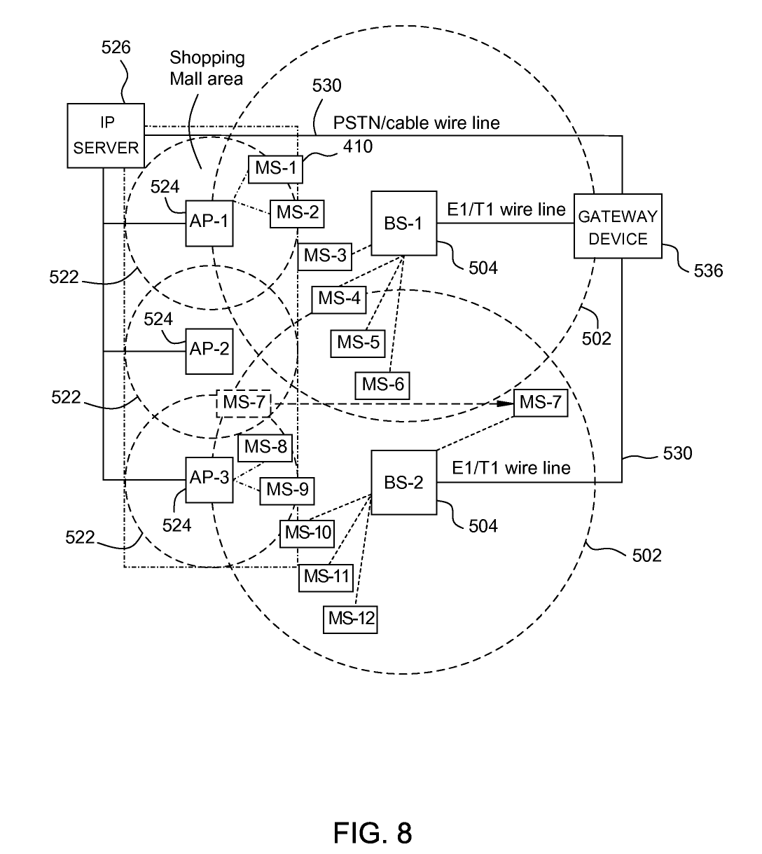

The MS may maintain the short-range RAT connection while it is in low speed mobility mode. However, when the MS is in high speed mobility mode, the MS may be directed to switch back to a long-range RAT connection. This scenario is illustrated in FIG. 8, which shows MS-7 in high speed mobility mode, having moved from the coverage area of short-range BS 2 into the coverage area of long-rage BS 2. As illustrated, in this example, MS-7 has been directed to establish a connection via long-range BS 2.

An MS in high speed mobility mode may be directed to terminate a short-range RAT connection before establishing a long-range RAT connection. However, in some cases, this may not be possible as the MS may be traveling at too high a speed or may have already left the coverage area of the short-range RAT.

For certain embodiments, multiple different short-range RATs and/or multiple different long-range RATs may be supported. In such cases, a network may determine a suitable RAT for a connection based on different factors. For example, if there are multiple short-range connections, the MS may be directed to connect via a short range RAT with the strongest signal strength, the nearest access point, or that is most suitable for a given service (e.g., video streaming or a voice call). For voice call applications, in order to support seamless switching between different RATs and between wireless and wireline protocols, the mobile device may need to provide the VoIP capability (e.g., via Wi-Fi or WiMAX).

With multiple long-range RATs supported, a “mid-speed” mobility mode may also be considered and a particular long-range RAT may be given preference in this mode. For example, WiMAX may be considered more suitable for a mid-range RAT suitable for mid-speed mobility, while it may not be ideal for the highest speeds, it may provide better data rates when an MS it at a suitable medium speed.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 702-708 illustrated in FIG. 7 correspond to means-plus-function blocks 702A-708A illustrated in FIG. 7A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of providing a multi-mode mobile station access to a network, comprising:
determining a location of the mobile station while the mobile station is connected to the network via a long-range radio access technology (RAT) base station;
determining a moving speed of the mobile station;
identifying, based at least in part on the location, a short-range RAT access point available to connect the mobile station to the network; and
directing the mobile station to switch to a connection to the network via the short-range RAT access point if the moving speed is below a threshold value.

2. The method of claim 1, wherein determining a location of the mobile station comprises obtaining global positioning system (GPS) coordinates for a location of the mobile station.

3. The method of claim 1, wherein determining a location of the mobile station comprises determining a location of the mobile station based on an identification of at least one of: a short range RAT access point the mobile station is communicating with and a long-range RAT base station the mobile station is communicating with.

4. The method of claim 1, wherein identifying a short-range RAT access point available to connect the mobile station to the network comprises:
identifying a short-range RAT access point from a database of short-range RAT access points based on the location.

5. The method of claim 1, wherein directing the mobile station to establish a connection to the network via the short-range RAT access point comprises:
directing the mobile station to establish a connection to the network via the short-range RAT access point concurrent with a connection to the network via the long-range RAT base station; and
subsequently directing the mobile station to handover to the short-range RAT access point.

6. (canceled)

7. The method of claim 1, further comprising:
directing the mobile station to re-establish a connection to the network via the long-range RAT base station if the moving speed exceeds a threshold value.

8. The method of claim 7, wherein determining a moving speed of the mobile station comprises determining a moving speed of the mobile station based on the determined location and a previously determined location.

9-10. (canceled)

11. An apparatus for providing a multi-mode mobile station access to a network, comprising:
logic for determining a location of the mobile station while the mobile station is connected to the network via a long-range radio access technology (RAT) base station;
logic for determining a moving speed of the mobile station;
logic for identifying, based at least in part on the location, a short-range RAT access point available to connect the mobile station to the network; and
logic for directing the mobile station to switch to a connection to the network via the short-range RAT access point if the moving speed is below a threshold value.

12. The apparatus of claim 11, wherein the logic for determining a location of the mobile station is configured to obtain global positioning system (GPS) coordinates for a location of the mobile station.

13. The apparatus of claim 11, wherein the logic for determining a location of the mobile station is configured to determine a location of the mobile station based on an identification of at least one of: a short range RAT access point the mobile station is communicating with and a long-range RAT base station the mobile station is communicating with.

14. The apparatus of claim 11, wherein the logic for identifying a short-range RAT access point available to connect the mobile station to the network is configured to:
identify a short-range RAT access point from a database of short-range RAT access points based on the location.

15. The apparatus of claim 11, wherein the logic for directing the mobile station to establish a connection to the network via the short-range RAT access point is configured to:
direct the mobile station to establish a connection to the network via the short-range RAT access point concurrent with a connection to the network via the long-range RAT base station; and
subsequently direct the mobile station to handover to the short-range RAT access point.

16. (canceled)

17. The apparatus of claim 11, further comprising:
logic for directing the mobile station to re-establish a connection to the network via the long-range RAT base station if the moving speed exceeds a threshold value.

18. The apparatus of claim 17, wherein the logic for determining a moving speed of the mobile station is configured to determine a moving speed of the mobile station based on the determined location and a previously determined location.

19-20. (canceled)

21. An apparatus for providing a multi-mode mobile station access to a network, comprising:
means for determining a location of the mobile station while the mobile station is connected to the network via a long-range radio access technology (RAT) base station;
means for determining a moving speed of the mobile station;
means for identifying, based at least in part on the location, a short-range RAT access point available to connect the mobile station to the network; and
means for directing the mobile station to switch to a connection to the network via the short-range RAT access point if the moving speed is below a threshold value.

22. The apparatus of claim 21, wherein the means for determining a location of the mobile station is configured to obtain global positioning system (GPS) coordinates for a location of the mobile station.

23. The apparatus of claim 21, wherein means logic for determining a location of the mobile station is configured to determine a location of the mobile station based on an identification of at least one of: a short range RAT access point the mobile station is communicating with and a long-range RAT base station the mobile station is communicating with.

24. The apparatus of claim 21, wherein the means for identifying a short-range RAT access point available to connect the mobile station to the network is configured to:
identify a short-range RAT access point from a database of short-range RAT access points based on the location.

25. The apparatus of claim 21, wherein the means for directing the mobile station to establish a connection to the network via the short-range RAT access point is configured to:
direct the mobile station to establish a connection to the network via the short-range RAT access point concurrent with a connection to the network via the long-range RAT base station; and
subsequently direct the mobile station to handover to the short-range RAT access point.

26. (canceled)

27. The apparatus of claim 21, further comprising:
means for directing the mobile station to re-establish a connection to the network via the long-range RAT base station if the moving speed exceeds a threshold value.

28. The apparatus of claim 27, wherein the means for determining a moving speed of the mobile station is configured to determine a moving speed of the mobile station based on the determined location and a previously determined location.

29-30. (canceled)

31. A computer-program product for providing a multi-mode mobile station access to a network, comprising a computer readable medium having instructions stored thereon, the instructions being executable by one or more processors and the instructions comprising:
instructions for determining a location of the mobile station while the mobile station is connected to the network via a long-range radio access technology (RAT) base station;
instructions for determining a moving speed of the mobile station;
instructions for identifying, based at least in part on the location, a short-range RAT access point available to connect the mobile station to the network; and
instructions for directing the mobile station to switch to a connection to the network via the short-range RAT access point if the moving speed is below a threshold value.

32. The computer-program product of claim 31, wherein the instructions for determining a location of the mobile station comprise instructions for obtaining global positioning system (GPS) coordinates for a location of the mobile station.

33. The computer-program product of claim 31, wherein instructions for determining a location of the mobile station comprise instructions for determining a location of the mobile station based on an identification of at least one of: a short range RAT access point the mobile station is communicating with and a long-range RAT base station the mobile station is communicating with.

34. The computer-program product of claim 31, wherein instructions for identifying a short-range RAT access point available to connect the mobile station to the network comprise:
instructions for identifying a short-range RAT access point from a database of short-range RAT access points based on the location.

35. The computer-program product of claim 31, wherein the instructions for directing the mobile station to establish a connection to the network via the short-range RAT access point comprise:
instructions for directing the mobile station to establish a connection to the network via the short-range RAT access point concurrent with a connection to the network via the long-range RAT base station; and
instructions for subsequently directing the mobile station to handover to the short-range RAT access point.

36. (canceled)

37. The computer-program product of claim 31, further comprising:
instructions for directing the mobile station to re-establish a connection to the network via the long-range RAT base station if the moving speed exceeds a threshold value.

38. The computer-program product of claim 37, wherein the instructions for determining a moving speed of the mobile station comprise instructions for determining a moving speed of the mobile station based on the determined location and a previously determined location.

39-40. (canceled)
